(19) United States
(12) Patent Application Publication
(10) Pub. No.: US 2021/0355950 A1
(43) Pub. Date: Nov. 18, 2021

(54) ARTIFICIAL INTELLIGENT FAN SYSTEM

(71) Applicant: Sarbjit S. PARHAR, Mississauga (CA)

(72) Inventor: Sarbjit S. PARHAR, Mississauga (CA)

(21) Appl. No.: 17/321,056

(22) Filed: May 14, 2021

Related U.S. Application Data
(60) Provisional application No. 63/025,729, filed on May 15, 2020.

(51) Int. Cl. F04D 25/10; G06N 3/08; F04D 25/06; F04D 19/00; F04D 27/00

(52) U.S. Cl. CPC F04D 25/105; G06N 3/08; F04D 25/0666; F05D 2270/8041; F04D 27/004; F05D 2210/40; F04D 19/002

(57) ABSTRACT

A fan system includes a fan having a controllable speed setting or power setting; an optical camera directed outward from the fan and which provides optical data; a controller configured to: communicate with the optical camera, receive the optical data, control rotating directions and the speed setting or the power setting of the fan; and a processor configured to: receive the optical data, identify, using a machine learning model, directions of one or more targets in relation to the fan using the received optical data of the optical camera, access a data bank, determine, using the data bank, the speed setting or the power setting of the fan, and communicate with the controller to control the rotating directions of the fan and the speed setting or power setting of the fan based on the identified directions of one or more targets in relation to the fan.

### CROSS-REFERENCE TO RELATED APPLICATIONS

The present application claims priority from U.S. provisional patent application No. 63/025,729, entitled “ARTIFICIAL INTELLIGENT APPLIANCES”, filed May 15, 2020, the contents of which are incorporated herein by reference into the Detailed Description herein below.

### TECHNICAL FIELD

Example embodiments relate to appliances, for example fans, washers and microwaves.

### BACKGROUND

Present appliances may have too many functions and they can be complicated to operate. As well, the performance of appliances may be further improved. Many appliances require manual monitoring and operation.

It is desired to provide artificial intelligent appliances that can automatically operate and adjust settings and which do not require manual monitoring and operation.

### SUMMARY

Example embodiment relate to artificial intelligent appliances.

An example embodiment is a fan system which includes a fan having a controllable speed setting or power setting; an optical camera directed outward from the fan and which provides optical data; a controller configured to: communicate with the optical camera, receive the optical data, control rotating directions and the speed setting or the power setting of the fan; and a processor configured to: receive the optical data, identify, using a machine learning model, directions of one or more targets in relation to the fan using the received optical data of the optical camera, access a data bank, determine, using the data bank, the speed setting or the power setting of the fan, and communicate with the controller to control the rotating directions of the fan and the speed setting or power setting of the fan based on the identified directions of one or more targets in relation to the fan.

An example embodiment is a processor-implemented method for controlling a fan, comprises receiving optical data from an optical camera directed outward from the fan; identifying, using a machine learning model, directions of one or more targets in relation to the fan using the optical data; and communicating to control rotating directions of the fan based on the directions of one or more targets in relation to the fan.

An example embodiment is a washer system which comprises: a washer having controllable operational parameters; an optical camera which provides optical data at the washer; a controller configured to: communicate with the washer and the optical camera, and receive the optical data from the optical camera, control the operational parameters of the washer; and a processor configured to: receive the optical data, identify, using a machine learning model, types of laundry and quantities of the laundry loaded in the washer using received optical data from the optical camera and data sets stored in a data bank, and communicate with the controller to control the washer to operate using one or more specified operational parameters based on the types of laundry and the quantities of laundry.

An example embodiment is a microwave oven system, which comprises: a microwave oven having a controllable power setting; a thermal camera at the microwave oven and which provides temperature data of one or more cooking items in the microwave; an optical camera at the microwave oven and which provides optical data of the one or more cooking items in the microwave; a controller configured to: communicate with the optical camera and the thermal camera, receive the temperature data from the thermal camera, and control the microwave to control the power setting and the power on time; and a processor configured to: receive the optical data, identify using a machine learning model, the one or more cooking items and their quantities at the microwave oven using the received optical data of the optical camera, access a recipe data bank, determine, using the recipe data bank, one or more steps for cooking of the one or more cooking items in the microwave oven, and communicate with the controller to control the microwave oven to one or more specified power settings and the power on time based on the temperature data and the optical data, to achieve one or more of the steps for the cooking.

### BRIEF DESCRIPTION OF THE DRAWINGS

Reference will now be made, by way of example, to the accompanying drawings which show example embodiments, and in which:

FIG. 1 is a front view of a fan system, according to one embodiment;

FIG. 2 is diagram showing an exemplary operation of the fan in FIG. 1;

FIG. 3 is diagram showing exemplary controls of the fan in FIG. 1;

FIG. 4 is a front view of a washer system, according to one embodiment;

FIG. 5 is diagram showing an exemplary operation of the washer in FIG. 3;

FIG. 6 is diagram showing exemplary controls of the washer in FIG. 3;

FIG. 7 is a front view of a microwave system, according to one embodiment;

FIG. 8 is diagram showing an exemplary operation of the microwave in FIG. 7; and

FIG. 9 is diagram showing exemplary controls of the microwave in FIG. 7.

Similar reference numerals may have been used in different figures to denote similar components.

### DETAILED DESCRIPTION

Example embodiments relate to appliances, for example fans, washers and microwaves.

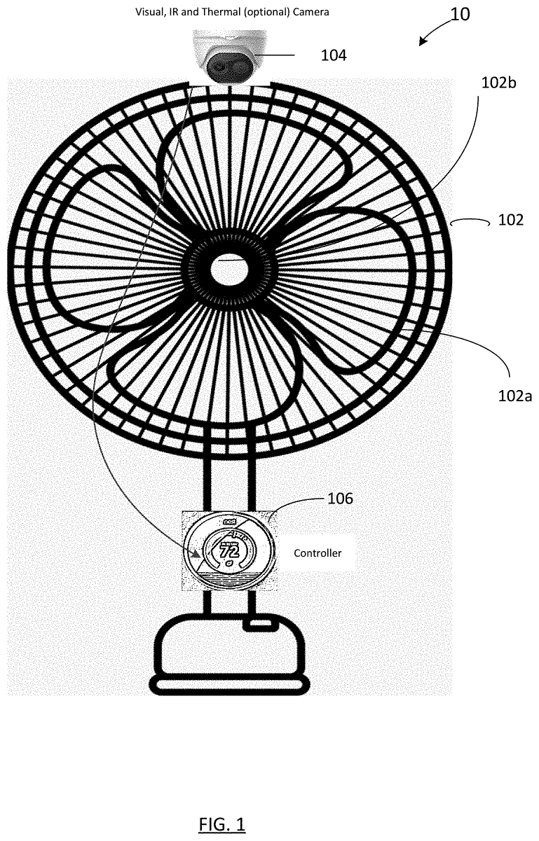

Reference is made to FIGS. 1-3. A fan system 10 may include a fan 102 having a controllable speed setting or power setting; an optical camera 104 directed outward from the fan and which provides optical data; a controller 106 configured to: communicate, for example by or Bluetooth™, with the optical camera 104, receive the optical data, control rotating directions and the speed setting or the power setting of the fan 102; and a processor 107 configured to: receive the optical data, identify, using a machine learning model, directions of one or more targets in relation to the fan 102 using the received optical data of the optical camera 104, access a data bank, determine, using the data bank, the speed setting or the power setting of the fan 102, and communicate with the controller 106 to control the rotating directions of the fan 102 and the speed setting or power setting of the fan 102 based on the identified directions of one or more targets in relation to the fan 102. The controller 106 may be a smart thermostat, for example, Google® Nest®. The controller 106 may have one or more buttons for a user to control the fan 102. The controller 106 may have a display to show the information related to the fan system 10.

The controller 106 may be configured, for example, using software, to communicate to various cameras, such as visual, near IR and thermal cameras, temperature and humidity sensors, records video or images, processes images, hosts AI model containers, run inference on models and controls on time and power setting. The controller 106 may use Android or iOS applications.

The fan 102 is used to create a flow of air. The fan 102 may be a rotating fan. The fan 102 includes a plurality of vanes or blades 102a, and one or more electric motors to power the fan 102. The motors may be variable speed motors. The blades 102a act on the air to create airflow. The fan 102 may also include a rotating assembly of blades and hub 102b for directing the blades to a range of directions, such as an impeller, or rotor.

The processor 107 is configured to identify, using the machine learning model, directions of one or more targets in relation to the fan 102 may be perform based on the optical data and without user input. The one or more targets includes one or more people. The processor 107 is configured to identify, using the machine learning model, the presence of people within its range and locations or direction of people in relation to the fan 102. The processor 107 is configured to identify, using image classification of the machine learning model, one or more people. As well, The processor 107 is configured, using the machine learning model, to create a pixel-wise mask for each object in the image for recognizing the object(s) in the image.

The processor 107 may be in a cloud server or in a mobile computing device 110, or in the fan 102.

The controller 106 may be further configured to receive manual input to manually control the speed setting or the power setting of the fan 102.

The fan system 10 may further include a thermal camera for measuring a body temperature of the one or more targets. In an example, the thermal camera detects wavelengths depending on an absolute temperature of a source (e.g. a body).

The fan system 10 may further include an ambient temperature sensor for measuring an ambient temperature of a space in which the fan is located, wherein the processor 107 further determines the speed setting or power setting of the fan based on the ambient temperature. The fan system 10 may also include a humidity sensor for measuring an ambient humidity of a space.

The fan system 10 may further include a near infrared camera for providing second optical data during low light and/or dark ambient condition or when the optical camera 104 stops functioning, wherein the processor 107 is configured to identify, using the machine learning model, the locations of one or more targets in relation to the fan using second optical data.

The machine learning model may include a classical machine learning technique or neural network or a convolutional neural network. The processor 107 may be further configured to train the machine learning model using the optical data and the manual input via the controller 106.

The processor 107 may be further configured to receive user input to label, for the training of the machine learning model, speed setting or power setting of the fan 102, or to store and replay a speed setting or power setting from the optical data and the manual input via the controller 106.

The optical camera 104 detects visible spectrum. The thermal camera detects infrared spectrum. The optical camera 104 may be a single integrated camera including both the optical camera and the thermal camera. The optical camera 104 may be a single integrated camera including the optical camera, the near infrared camera and the thermal camera.

The fan system 10 may further include a microphone for the processor 107 to receive voice user input.

The fan system 10 may further include a speaker for the processor 107 to output audible communications.

The fan system 10 may further include a screen on the controller 106 to output communications.

In the fan system 10, the processor 107 or controller 106 is configured to communicate with a phone or mobile computing device 110. The controller 106 includes a thermostat configured to provide a signal in response to the body temperature.

Another embodiment is a processor-implementing method for controlling a fan 102, comprising: receiving optical data from an optical camera 104 directed outward from the fan 102; identifying, using a machine learning model, directions of one or more targets 112 in relation to the fan 102 using the optical data; and communicating to control rotating directions of the fan 102 based on the directions of one or more targets in relation to the fan 102.

The method may further comprises identifying, using the machine learning model, an identity of one or more targets 112; determine, using a data bank, a speed setting or power setting of the fan 102 based on the identity, and controlling the fan 102 using the speed setting or power setting of the fan 102.

The method may further comprises determining a body temperature of the one or more targets 112, and controlling a speed setting of the fan 102 based on the body temperature.

The method may further comprises controlling a speed setting of the fan 102 based on a difference between a body temperature of the one or more targets 112 and an ambient temperature of a space in which the fan 102 is located.

The method may further comprises displaying one or more of a speed setting of the fan 102, a duration of the speed setting, and an ambient temperature on a screen of the fan 102.

The method may further comprises communicating to continuously control the rotating directions of the fan 102 by tracking locations of the one or more targets 112.

In another embodiment, anon-transitory computer-readable medium containing instructions executable by a processor 107 for controlling a fan 102, the instructions comprising instructing for performing the methods described above.

For example, when a person walks in a room, the MI ML models detects the presence of the person. Image Recognition API may compares the person's image with the data bank and determines fan speed based on the person's preference and/or difference between the human body and ambient temperature, if the thermal camera is used.

The controller 106 may assess the proximity based on the image processing. The direction of the fan 102 may be adjusted towards the person and the fan 102 may be turned on.

Depending on the ambient temperature and the person's body thermal image from the thermal camera, if used the speed may be modulated for optimal comfort and liking.

The person location may be continually tracked using the visual camera or IR Camera (in low light conditions at night) or thermal camera 104, if used. Once the person is identified and tracked, the fan 102 may turn towards the person.

In some examples, the fan system 10 may turn on the fan 102 in presence of users in a range detectable by the fan system 10, turn off when no user is present in the range detectable by the fan system 10, direct the air towards users, modulate speed as per the environmental and needs of the users, and/or performs all of the functionality during the day or night in low light condition.

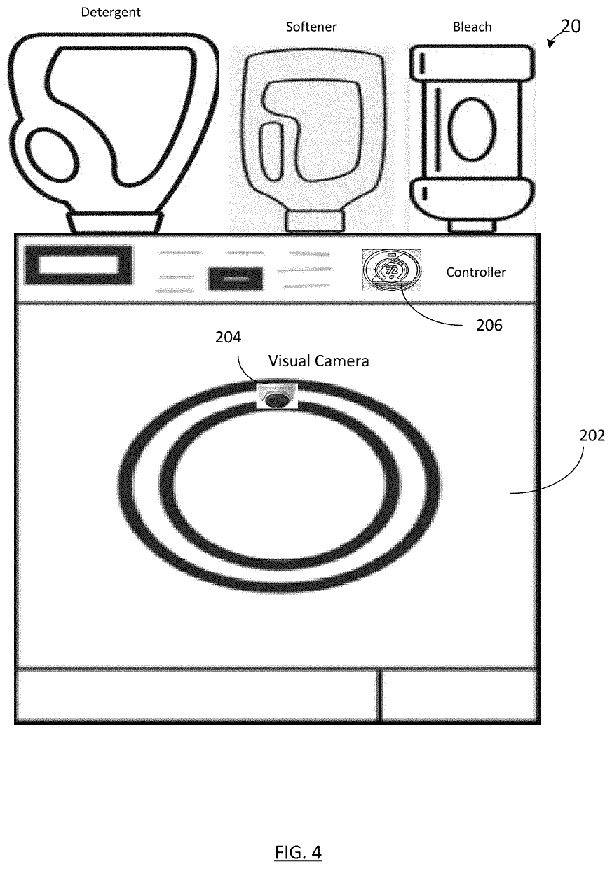

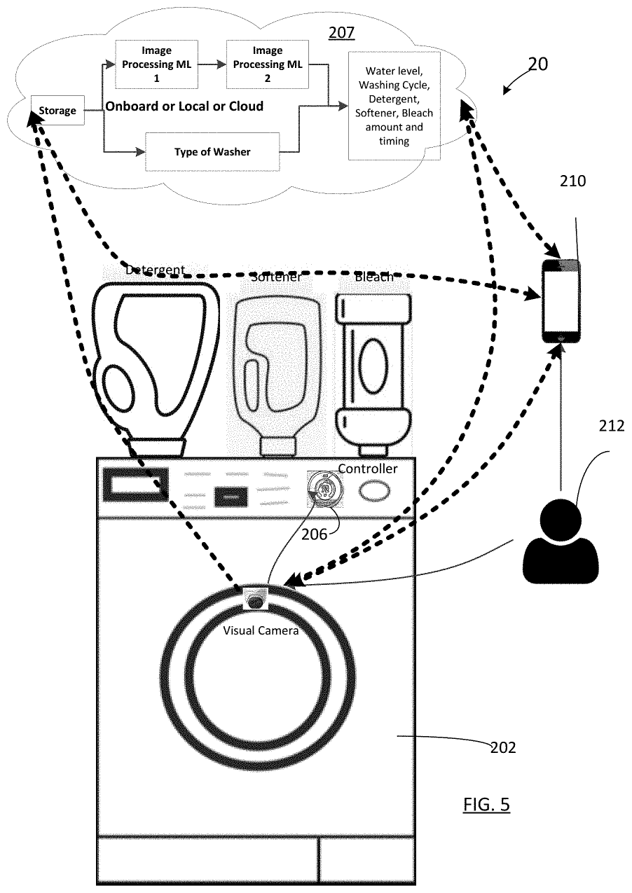

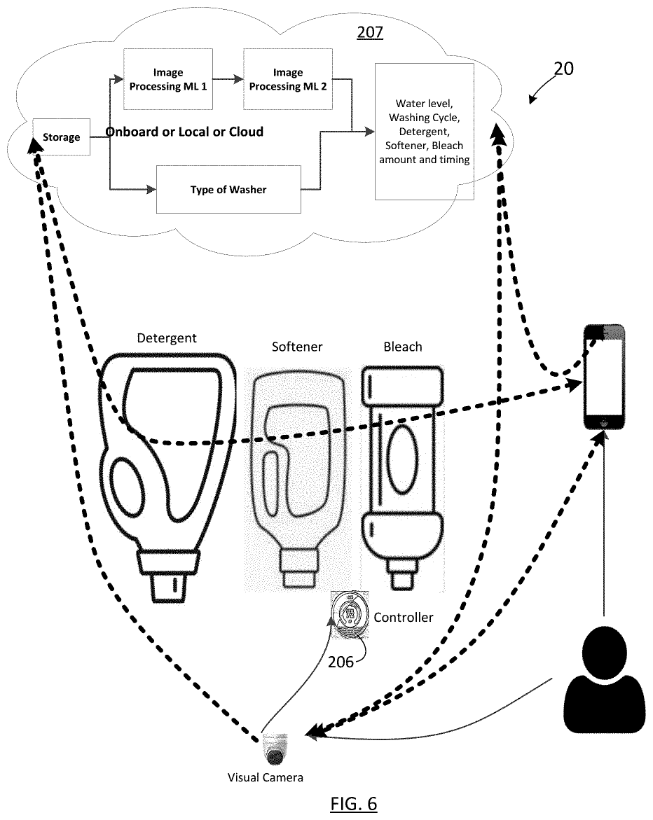

Reference is made to FIGS. 4-6. Another embodiment is a washer system 20 which may include: a washer 202 having controllable operational parameters; an optical camera 204 which provides optical data at the washer 202; a controller 206 configured to: communicate, for example by Wi-Fi™ or Bluetooth™ with the washer 202 and the optical camera 204, receive the optical data from the optical camera 204, control the operational parameters of the washer 202; and a processor 207 configured to: receive the optical data, identify, using a machine learning model, types of laundry and quantities of the laundry loaded in the washer using received optical data from the optical camera 204 and data sets stored in a data bank, and communicate with the controller 206 to control the washer to operate using one or more specified operational parameters based on the types of laundry and the quantities of laundry. The controller 206 may be a smart thermostat, for example, Google Nest. In an example, the controller 206 is configured to receive manual input to manually control the operational parameters of the washer 202

The controller 206 may include one or more buttons for receiving inputs form a user. The controller 206 may include a display for displaying information of the washer system 20. The controller 206 may be configured to record and control on time and power setting of the washer 202, and connects to the optical Camera 204. The controller 206 may use Android or iOS applications.

In some examples, the washer system 20 may, based on the clothing color, amount, type and/or dirtiness, automatically select the wash cycle using Artificial Intelligence/Machine Learning to recognize the items to be washed, automatically dispense the number of detergent pods at appropriate time in the wash cycle and/or appropriate amount of liquid or powder detergent, bleach and fabric softener at the appropriate timing in the wash cycle.

The washer 202 include a PODS, Liquid and/or powder Detergent Auto dispenser, a liquid Softener Auto Dispenser, and a liquid Bleach Auto Dispenser. The auto dispensers are controlled by the controller 206. The auto dispensers can also sense the low and out levels of the detergent and communicate to the controller 206. The controller 206 may n turn displays relevant information on the screens and/or communicates to the customer via the phone application. For example, the washer information i.e. wash cycle, drum Speed, Temp and time settings may be displayed on the Controller screen.

The washer 202 may include a water pump for circulating the water through the wash cycle and also for draining the water during the spin cycle, a water inlet control valve for controlling water flowing into the washer 20, a perforated drum for receiving clothes or other objects for washing, an agitator or paddles for moving the clothes around during the wash and helping the clothes rub together while washing, a washing machine motor combined with the agitator to turns the drum and produces a rotator motion, a Printed circuit board (PCB) for controlling operation of the washer 202. The controller 206 may communicate with the PCB to control the washer 202.

The identifying may be perform based on the optical data and without user input. The data sets may be images or selected features of images.

The one or more specified operations parameters include a factory predefined setting that includes two or more of the specified operations parameters.

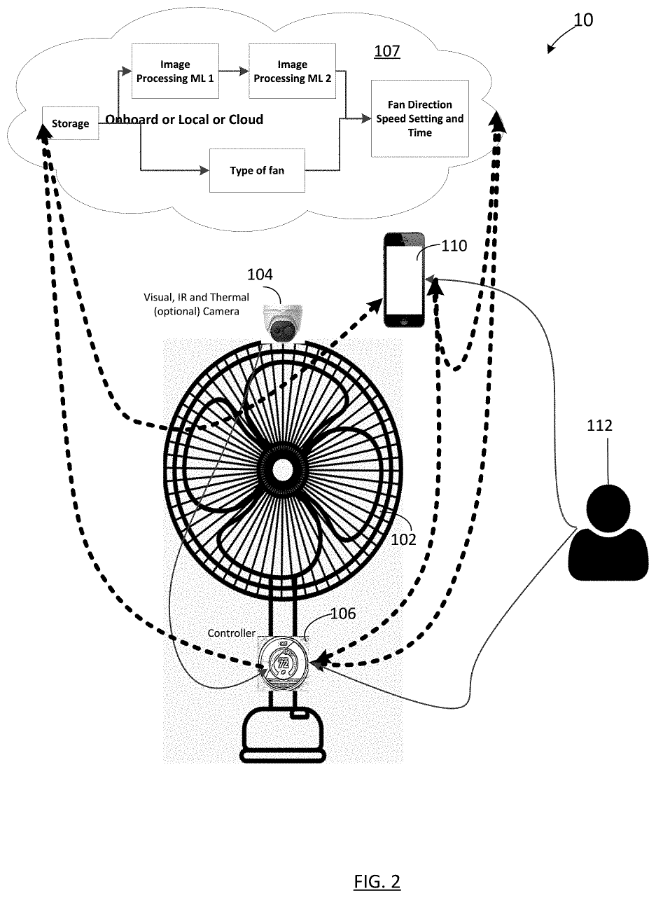

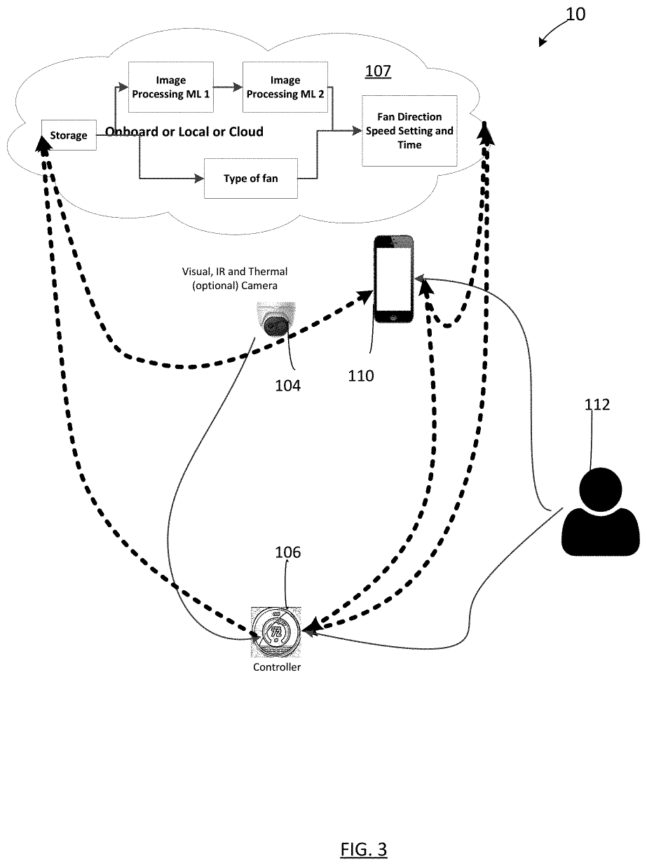

As illustrated in FIGS. 2 and 3, the one or more specified operations parameters comprising a type of the washer, a drum speed of the washer, a temperature of water, a power setting, a laundry duration, a water level, a washing cycle, an detergent amount and its dispensing time, an softener amount and its dispensing time, and a bleach amount and its dispensing time.

The processor 207 may be in a cloud server, in a mobile computing device 210, or in the washer 202.

The machine learning model includes a classical machine learning technique or neural network or a convolutional neural network. The processor 207 may be further configured to train the machine learning model using the optical data, and one or more operational parameters set from the manual control of the washer 202 via the controller 206.

The processor 207 may be further configured to receive user input to label, for the training of the machine learning model: i) the types of laundry, and/or ii) operational parameters of the washer 202.

The processor 207 may be further configured to store one or more operational parameters from the optical data, and operational parameters set by the manual control of the washer via the controller 206.

In the washer system 20, the optical camera 204 detects visible spectrum. The optical camera 204 may determine the color, dirtiness, types and/or amount of clothing. The camera 204 may be \turned on for taking video and/or pictures, when the front door of the washer 202 is opened up and when washer 202 is empty.

In the washer system 20, AI/ML image processing in washer system 20 ascertains the amount, type, color and/or dirtiness of the clothes. AI/ML Image APIs runs the inference on the collected images through the pre-trained AI/ML Models. AI/ML includes but not limited to Object detection and Image Classification to ascertain the type of clothing, color, dirtiness and/or amount of clothing. Depending the results from the AI/ML inference models and Washing machine model, the controller 206 may recommend the water level, washing cycle, liquid detergent amount, softener amount, bleach amount and timing are determined. During the Wash Cycle, the controller 206 controls every step of the Washing cycle from water level, detergent, softener and Bleach dispensing along with the timing, etc.

The Controller 206 also instructs the auto dispenser to dispense PODs and/or liquid or powder detergent and/or bleach and/or softener. The auto dispenser is equipped with low and out sensors for the PODs, detergent and/or bleach and/or softener. The low and out information is communicated to the controller 206. In case of “out”, washer is not capable of running the “Smart” mode.

All of the information of the washer system 20 may be also sent to the APP on the phone 210. A person can either pause or stop the washer or change the settings from the phone, in the middle of the washing cycle. Once the wash cycle is complete or in case of emergency, the power is turned off

The manual control of the controller 206 can be used for “Training the model” and for saving personal preferences for different types of clothing. Overtime, this information is saved into the Data bank and can be recalled by voice or through the phone or the Controller screens.

In some examples, the washer system 20 may further comprise a light next to the camera 204 for shining light at the clothes. The light is turned on when the door of the washer 202 is opened up. The light also illuminates the customer action of loading the washer. During the loading process, the camera 204 may take the video and/or pictures of the clothes and send the image to the controller 206 for processing.

The camera 204 and light may be added to the stationary (non-rotating) rim of the washer 202 near the front door. The camera 204 communicates with the onboard washer controller 206 with an optional display. The light is controlled by the controller 206.

Once the clothes are loaded in the washer 202 and front door is closed, Washer 202 can be turned on by the customer in either the “Smart” (default mode) or “Manual” mode with the knob on the controller 206 or alternatively through the voice commands and/or from the phone 210. Smart mode entails auto wash cycle selection and auto dispensing of the detergent, bleach and softener. Manual mode entails customer loading the detergent, softener and/bleach and selecting the wash cycle, manually.

The user can also decide to have a delayed start from the controller 206 or phone 210. Once the Start cycle begins, the drum starts turning. Camera 204 takes the video and/or images every few seconds during this time as well. Once the video and or images are taken, the light and camera 204 are turned off

The washer system 20 may further comprise a microphone for the processor 207 to receive voice user input.

The washer system 20 may further comprise a speaker for the processor 207 to output audible communications.

The washer system 20 may further comprise a screen on the controller 206 to output communications. The controller 206 may be configured to display the one or more specified operational parameters on the screen. The controller 206 may be configured to light up the screen when the controller 206 detects a person 212 in proximity of the washer 202.

The washer system 20 may further comprise a detergent dispenser, a softener dispenser, and a bleach dispenser, controllable by the processor 207 or the controller 206, to automatically dispense detergent, softener, and bleach, respectively. The controller 206 may be configured to dispense detergent, softener, and/or bleach at predetermined times.

The processor 207 or the controller 206 is configured to communicate with a phone or mobile computing device 210.

In an example, the washer 202 is included in a washer dryer combination.

Another embodiment is a processor-implemented method for controlling the washer 202, comprising: receiving optical data detected by an optical camera 204, identifying, using a machine learning model, types of laundry and quantities of the laundry loaded in the washer 202, using received optical data from the optical camera 204 and data sets stored in a laundry data bank, determining one or more operational parameters based on the types of laundry and the quantities of laundry, and communicating to control the washer based on the one or more operational parameters.

Another embodiment is a non-transitory computer-readable medium containing instructions executable by a processor 207 for controlling a washer 202, the instructions comprising instructing for performing the method above.

Washer system 20 may be installed on a Washer Dryer Combo to provide a complete Washing Drying process automatic from loading of dirty clothes to dry clean clothes.

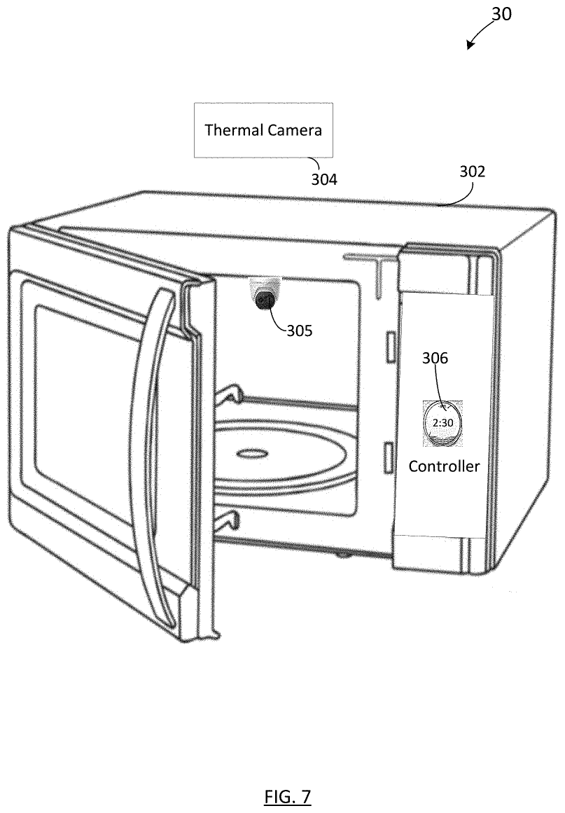

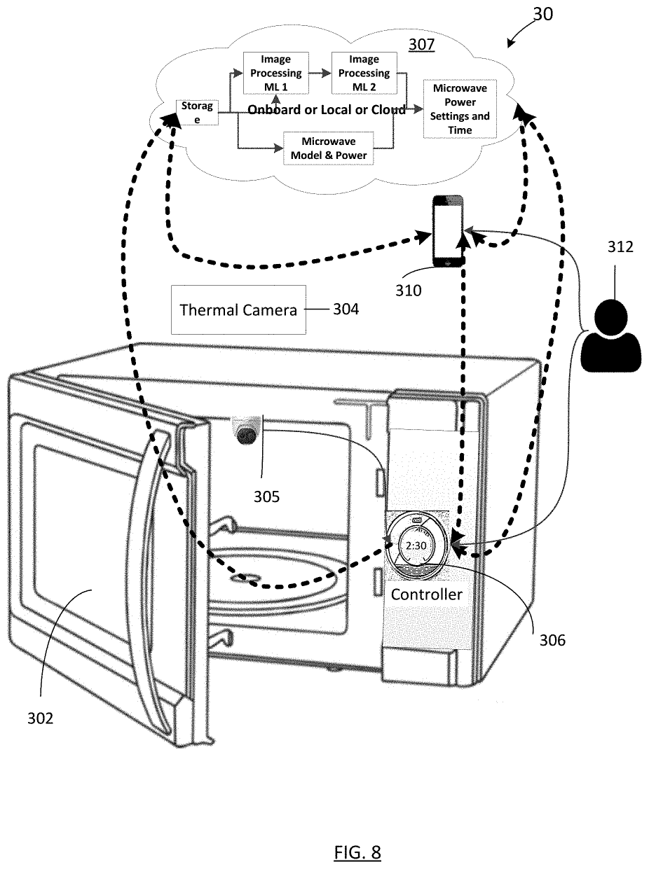

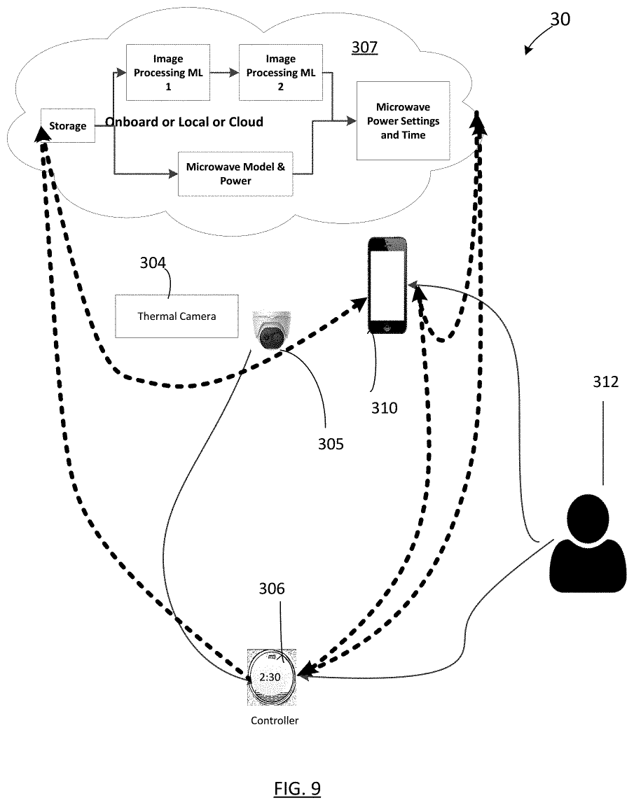

Reference is made to FIGS. 7-9. Another embodiment is a microwave oven system 30 may include: a microwave oven 302 having a controllable power setting; a thermal camera 304 at the microwave oven 302 and which provides temperature data of one or more cooking items in the microwave oven 302; an optical camera 305 at the microwave oven 302 and which provides optical data of the one or more cooking items in the microwave oven 302; a controller 306 configured to: communicate, for example by or Bluetooth™, with the optical camera 305 and the thermal camera 304, receive the temperature data from the thermal camera 304, control the microwave oven 302 to control the power setting; and a processor 307 configured to: receive the optical data, identify using a machine learning model, the one or more cooking items and their quantities at the microwave oven 302 using the received optical data of the optical camera 305, access a recipe data bank, determine, using the recipe data bank, one or more steps for cooking of the one or more cooking items in the microwave oven 302, and communicate with the controller 306 to control the microwave oven 302 to one or more specified power settings based on the temperature data and the optical data, to achieve one or more of the steps for the cooking. The identifying may be performed based on the optical data and without user input. The controller 306 may be a smart thermostat, for example, Google Nest. In an example, the controller 306 is configured to receive manual input to manually control the power setting of the microwave oven 302.

The microwave system 30 may reduce manpower and attention required in cooking by automation, and may also improve quality of cooked food.

The microwave oven 302 may include a high-voltage power source, commonly a simple transformer or an electronic power converter, for passing energy to the magnetron, a high-voltage capacitor connected to the magnetron, transformer and via a diode to the chassis, a cavity magnetron for converting high-voltage electric energy to microwave radiation, a magnetron control circuit for controlling operations of the microwave oven 302, a short waveguide for coupling microwave power from the magnetron into the cooking chamber, a turntable and/or metal wave guide stirring fan, and a control panel for receiving input from a user. The controller 306 may communicate with the magnetron control circuit to control the microwave oven 302.

The controller 306 may include one or more buttons for receiving input from a user, and may include a screen for display information related to the microwave system 30. The controller 306 may be configured to record and control on time and power setting of the microwave 302, and communicate with the Visual and Thermal Cameras 304 and 305. The controller 306 may use Android or iOS applications.

The processor 307 may be further configured to communicate with the controller 306 to control the microwave oven 302 to the one or more specified power settings for one or more specified durations based on the recipe bank to achieve one or more of the steps for the cooking. The processor 307 may be in a cloud server, in a mobile computing device 310, in the controller 306, or in the microwave oven 302. The processor 307 may be configured to output includes manual instructions in relation to one or more of the steps for the cooking. The processor 307 may be further configure to, based on the optical data, determine that the manual instructions were performed.

The controller 306 may be configured to maintain the control of the power setting of the microwave oven 302 using the thermal camera 304 for measuring the temperature of the visible surfaces.

The machine learning model includes a classical machine learning technique or neural network or a convolutional neural network. The processor 307 is further configured to train the machine learning model using the optical data, the temperature data, and the manual control of the microwave oven 302 via the controller 306. The processor 307 is further configured to receive user input to label, for the training of the machine learning model: i) a classification of the one or more cooking items, and/or ii) a cooking outcome of the one or more cooking items.

The processor 307 may be further configured to store and replay a professional recipe from the optical data, the temperature data, and the manual control of the microwave oven 302 via the controller 306.

The optical camera 305 detects visible spectrum. The thermal camera 304 detects infrared spectrum based on the temperature of one or more of the cooking items in the microwave oven 302. A single integrated camera may include both the optical camera 305 and the thermal camera 304. The camera 305 may be used to identify what is being cooked and how much food being cooked.

The microwave oven system 30 may further comprise a microphone for the processor 307 to receive voice user input.

The microwave oven system 30 may further comprise a speaker for the processor 307 to output audible communications.

The microwave oven system 30 may further comprise a screen on the controller 306 to output communications. The controller 306 may be configured to output to the screen on the controller 306 a next manual step or warnings.

The processor 307 or controller 306 may be configured to communicate with a phone or mobile computing device 310. The controller 306 may include a thermostat configured to provide a signal in response to the temperature data.

Another embodiment is a processor-implemented method for controlling a microwave oven 302 which may include: receiving optical data detected by an optical camera 305, identifying, using a machine learning model, one or more cooking items and their quantities in the microwave oven using the received optical data of the optical camera 305, determining, using a recipe data bank, one or more steps for cooking of the one or more cooking items in the microwave oven 302, receiving temperature data detected by a thermal camera 304 at the microwave oven 302, and communicating to control the microwave oven 302 to one or more specified power settings and power on time based on the temperature data and the optical data, to achieve one or more of the steps for the cooking.

The processor-implemented method may further include communicating to control the microwave oven 302 the one or more specified power settings for one or more specified time durations based on the temperature data and the optical data, to achieve one or more of the steps for the cooking.

In another embodiment, a non-transitory computer-readable medium containing instructions executable by a processor 307 for controlling the microwave oven 302, the instructions comprising instructing for performing the methods above.

In another embodiment, a microwave oven system 30 may include: a microwave oven 302 having a controllable power setting; an optical camera 305 at the microwave oven 302 and which provides optical data; a thermal camera 304 at the microwave oven 302 and which provides temperature data of one or more of the cooking items within the microwave oven 302; and a controller 306 configured to: receive the temperature data and the optical data, identify, using a machine learning model, one or more cooking items and their quantities at the microwave oven 302 using the received optical data, and control the power setting and the power on time of the microwave oven 302 based on the one or more cooking items and their quantities.

The controller 306 may be configured receive manual input to manually control the power setting of the microwave 320.

In another embodiment, a microwave oven system 30 may include: a microwave oven 302 having a controllable power setting and a controllable power on time; a temperature sensor for detecting temperature of one or more cooking items (e.g. food) in the microwave oven 302 and outputting temperature data; one or more controllers (in the microwave oven 302) to adjust the power setting of the microwave oven 302 and the power on time of the microwave oven; and a controller 306 configured to receive the temperature data of the one or more cooking items to control the power setting and the power on time of the microwave oven 302 using the one or more motor controllers. The controller may be configured receive manual input to manually control the power setting and the power on time of the microwave oven 302.

In some examples, a user walks in front of the Microwave Controller 306, the proximity and motion sensor lits up the display of the controller 306 with a configurable message.

The Visual Camera 304 takes the image of what's being cooked when there is a motion in front of the camera 304. Camera 304 may also takes video continuously or images every few seconds. The video and Images are transferred to cloud, such as Amazon AWS or Azure. The video may be transformed to the images in the cloud. An Image Recognition API compares the food image with the data bank and decides action based on the amount (quantity) of the food and the microwave power. An Image Recognition API sends the actions to the Controller 306. Alternatively, the food bank recipes and Microwave 302 can also be accessed through the voice commands and/or phone.

The information, such as Power, Temp and time settings are displayed on the Controller screen. All of the information may also be sent to the user's phone 310. The user may edit and confirm the settings by pressing the Controller button or from the phone 310. If required, the adjustments can be made by rotating the knob of the controller 306 by the user.

The user can also select a delayed start option. Once confirmed by the user, the microwave 302 starts the heating/cooking cycle. The Thermal camera 305 may be located on the hood, and may keep monitoring the temperature of the food being cooked.

The Thermal camera 305 sends the information directly to the controller 306. The user can control turning off/on power and the cooking time by modulating the power form the controller 306. At pre-determined intervals, the power setting is adjusted as per the recipe.

If the food flipping and/or additional condiments are required, a message may be sent to the user's phone 310, such as a text message and internally within the app and display on the screen of the controller 306 as a reminder.

The controller 306 can check whether the instructions are followed by taking the images of the food form the camera 304. If not, the controller 306 can remind the chef later or turn off the food to prevent over-cooking. As well, the thermal camera 305 may monitor the food internal temperature.

Once the food is cooked or in case of emergency, the controller 306 may be configured to turn the power off

The Controller 306 may keeps the display on till the microwave is on and food is hot, even after the power is turned off

Microphone to take all instructions vis voice and speaker for replying back. This setup can also be used for “Training the model” for the new recipes. For example, in case a new dish is being prepared, the camera 304, 305 and the voice commands can record the ingredients, their approx. volume and the sequence in which the ingredients are used. Overtime, the controller 306 can save the new recipes into the Data bank. The display screen can be used for showing the same or different steps of the recipe.

Certain adaptations and modifications of the described embodiments can be made. Therefore, the above discussed embodiments are considered to be illustrative and not restrictive.

What is claimed is:

1. A fan system, comprising:
a fan having a controllable speed setting or power setting;
an optical camera directed outward from the fan and which provides optical data;
a controller configured to:
communicate with the optical camera,
receive the optical data,
control rotating directions and the speed setting or the power setting of the fan; and
a processor configured to:
receive the optical data,
identify, using a machine learning model, directions of one or more targets in relation to the fan using the received optical data of the optical camera,
access a data bank,
determine, using the data bank, the speed setting or the power setting of the fan, and
communicate with the controller to control the rotating directions of the fan and the speed setting or power setting of the fan based on the identified directions of one or more targets in relation to the fan.

2. The fan system as claimed in claim 1, wherein the controller is further configured to receive manual input to manually control the speed setting or the power setting of the fan.

3. The fan system as claimed in claim 1, further comprising a thermal camera for measuring a body temperature of the one or more targets.

4. The fan system as claimed in claim 3, wherein the thermal camera detects wavelengths depending on an absolute temperature of a source.

5. The fan system as claimed in claim 1, further comprising an ambient temperature sensor for measuring an ambient temperature of a space in which the fan is located, wherein the processor further determines the speed setting or power setting of the fan based on the ambient temperature.

6. The fan system as claimed in claim 1, further comprising a near infrared camera for providing second optical data during low light and/or dark ambient condition, wherein the processor is configured to identify, using the machine learning model, the directions of one or more targets in relation to the fan using second optical data.

7. The fan system as claimed in claim 1, wherein the processor is in a cloud server.

8. The fan system as claimed in claim 1, wherein the processor is in a mobile computing device.

9. The fan system as claimed in claim 1, wherein the processor is in the fan.

10. The fan system as claimed in claim 1, wherein the machine learning model includes a classical machine learning technique or neural network or a convolutional neural network.

11. The fan system as claimed in claim 2, wherein the processor is further configured to train the machine learning model using the optical data and the manual input via the controller.

12. The fan system as claimed in claim 11, wherein the processor is further configured to receive user input to label, for the training of the machine learning model, speed setting or power setting of the fan.

13. The fan system as claimed in claim 2, wherein the processor is further configured to store and replay a speed setting or power setting from the optical data and the manual input via the controller.

14. The fan system as claimed in claim 1, wherein the optical camera detects visible spectrum.

15. The fan system as claimed in claim 6, wherein the near infrared camera detects infrared spectrum.

16. The fan system as claimed in claim 3, wherein a single integrated camera includes both the optical camera and the thermal camera.

17. The fan system as claimed in claim 1, further comprising a microphone for the processor to receive voice user input.

18. The fan system as claimed in claim 1, further comprising a speaker for the processor to output audible communications.

19. The fan system as claimed in claim 1, further comprising a screen on the controller to output communications.

20. The fan system as claimed in claim 1, wherein the identifying is perform based on the optical data and without user input.

21. The fan system as claimed in claim 1, wherein the one or more targets includes one or more people.

22. The fan system as claimed in claim 1, wherein the processor or controller is configured to communicate with a phone or mobile computing device.

23. The fan system as claimed in claim 3, wherein the controller includes a thermostat configured to provide a signal in response to the body temperature.

24. A processor-implemented method for controlling a fan, comprising:
receiving optical data from an optical camera directed outward from the fan;
identifying, using a machine learning model, directions of one or more targets in relation to the fan using the optical data; and
communicating to control rotating directions of the fan based on the directions of one or more targets in relation to the fan.

25. The method of claim 24, further comprising identifying, using the machine learning model, an identity of one or more targets; determine, using a data bank, a speed setting or power setting of the fan based on the identity, and controlling the fan using the speed setting or power setting of the fan.

26. The method of claim 24, further comprising determining a body temperature of the one or more targets, and controlling a speed setting of the fan based on the body temperature.

27. The method of claim 24, further comprising controlling a speed setting of the fan based on a difference between a body temperature of the one or more targets and an ambient temperature of a space in which the fan is located.

28. The method of claim 24, further comprising displaying one or more of a speed setting of the fan, a duration of the speed setting, and an ambient temperature on a screen of the fan.

29. The method of claim 24, further comprising communicating to continuously control the rotating directions of the fan by tracking locations of the one or more targets.

30. A non-transitory computer-readable medium containing instructions executable by a processor for controlling a fan, the instructions comprising instructing for performing the method of claim 24.
